(19) United States
(12) Patent Application Publication
(10) Pub. No.: US 2019/0225496 A1
(43) Pub. Date: Jul. 25, 2019

(54) METHOD FOR OXIDIZING MULTI-WALLED CARBON NANOTUBESES

(71) Applicants: Tsinghua University, Beijing (CN); HON HAI PRECISION INDUSTRY CO., LTD., New Taipei (TW)

(72) Inventors: DA-TAO WANG, Beijing (CN); KE WANG, Beijing (CN); JIA-PING WANG, Beijing (CN); SHOU-SHAN FAN, Beijing (CN)

(21) Appl. No.: 16/229,594

(22) Filed: Dec. 21, 2018

(30) Foreign Application Priority Data
Jan. 23, 2018 (CN) 201810064117.4

(51) Int. Cl. C01B 32/168

(52) U.S. Cl. CPC C01B 32/168; C01B 2202/06; C01P 2004/133; B82Y 40/00; C01P 2002/01; C01P 2002/82; C01P 2004/64

(57) ABSTRACT

A method for oxidizing multi-walled carbon nanotubes is provided. At least one multi-walled carbon nanotube is provided. The at least one multi-walled carbon nanotube is placed into a heating furnace filled with carbon dioxide gas. The heating furnace is heated to a temperature ranged from about 800° C. to about 950° C., and the at least one multi-walled carbon nanotube is oxidized in the carbon dioxide.

### CROSS-REFERENCE TO RELATED APPLICATIONS

This application claims all benefits accruing under 35 U.S.C. § 119 from China Patent Application No. 201810064117.4, filed on Jan. 23, 2018, in the China National Intellectual Property Administration, the contents of which are hereby incorporated by reference. The application is also related to copending applications entitled, “METHOD FOR MAKING BATTERY ELECTRODES”, filed **** (Atty. Docket No. US72966).

### FIELD

The present disclosure relates to a method for oxidizing multi-walled carbon nanotubes.

### BACKGROUND

In order to meet requirement in the field of lithium-sulfur batteries, it is often necessary to oxidize carbonaceous materials. The carbonaceous materials include mesoporous carbon, graphene, carbon nanotubes (CNTs) and carbon spheres. The carbon nanotubes are regarded as the most promising carbon materials due to their open-cell structure, high conductivity and one-dimensional flexible nanostructures.

Conventionally, the carbon nanotubes are generally oxidized by a concentrated sulfuric acid or a concentrated nitric acid. A plurality of oxygen-containing functional groups is distributed on a surface of oxidized carbon nanotubes. The plurality of oxygen-containing functional groups are negatively charged, and negative charges on surfaces of adjacent carbon nanotubes generate electrostatic repulsion, thereby promoting dispersions between the carbon nanotubes. However, known methods of oxidizing carbon nanotubes by acid often include a liquid heating processes. The liquid heating processes may be unsafe, and the resulting waste liquid is corrosive.

### BRIEF DESCRIPTION OF THE DRAWINGS

Implementations of the present technology will now be described, by way of embodiment only, with reference to the attached figures.

FIG. 1 is a flowchart of one embodiment of a method for oxidizing multi-walled carbon nanotubes.

FIG. 2 is a schematic view of one embodiment of a multi-walled carbon nanotubes oxidized in a carbon dioxide at a temperature 900° C.

FIG. 3 is a schematic view of one embodiment of a multi-walled carbon nanotube tube wall being completely peeled off after an oxidation reaction in the carbon dioxide.

FIG. 4 is a schematic view of one embodiment of the multi-walled carbon nanotube tube wall being partially peeled off after the oxidation reaction in the carbon dioxide.

FIG. 5 is a transmission electron micrograph of a multi-walled carbon nanotube oxidized by carbon dioxide.

FIG. 6 a transmission electron micrograph of a multi-walled carbon nanotube oxidized in air.

FIG. 7 is a thermogravimetric analysis curves comparison diagram of the multi-walled carbon nanotubes oxidized by carbon dioxide and in air, respectively.

FIG. 8 is a Raman spectra of a untreated multi-walled carbon nanotube, the carbon dioxide oxidized multi-walled carbon nanotube, and the air oxidized multi-walled carbon nanotube.

FIG. 9 is an infrared absorption spectra of the untreated multi-walled carbon nanotube, the carbon dioxide oxidized multi-walled carbon nanotubes and the air oxidized multi-walled carbon nanotube.

FIG. 10 is zeta potentials comparison diagram of the untreated multi-walled carbon nanotube, the carbon dioxide oxidized multi-walled carbon nanotube, and the air oxidized multi-walled carbon nanotube.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

Several definitions that apply throughout this disclosure will now be presented.

The term “comprise” or “comprising” when utilized, means “include or including, but not necessarily limited to”; it specifically indicates open-ended inclusion or membership in the so-described combination, group, series, and the like.

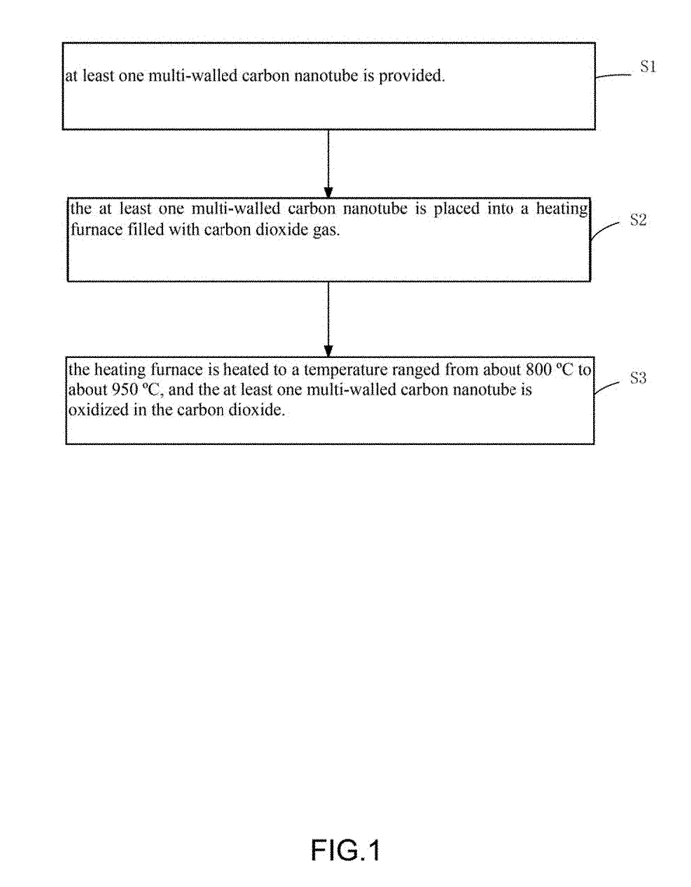

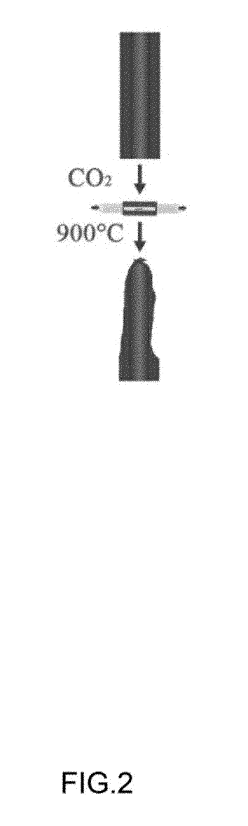

A flowchart is presented in accordance with an embodiment as illustrated. The embodiment of a method for oxidizing multi-walled carbon nanotubes 1 is provided by way of embodiment, as there are a variety of ways to carry out the method. The method 1 described below can be carried out using the configurations illustrated in FIGS. 1 to 2. Each block represents one or more processes, methods, or subroutines carried out in the exemplary method 1. Additionally, the illustrated order of blocks is by example only, and the order of the blocks can be changed. The exemplary method 1 can begin at block 51. Depending on the embodiment, additional steps can be added, others removed, and the ordering of the steps can be changed.

At block S1, at least one multi-walled carbon nanotube is provided.

At block S2, the at least one multi-walled carbon nanotube is placed into a heating furnace filled with carbon dioxide gas.

At block S3, the heating furnace is heated to a temperature ranged from about 800° C. to about 950° C., and the at least one multi-walled carbon nanotube is oxidized in the carbon dioxide.

At block S1, a diameter and a length of the at least one multi-walled carbon nanotube are not limited. In one embodiment, the length of each of the multi-walled carbon nanotube is about 50 μm or more.

The at least one multi-walled carbon nanotube may be one multi-walled carbon nanotube or a plurality of multi-walled carbon nanotubes. When the plurality of multi-walled carbon nanotubes is provided, arrangements of the plurality of multi-walled carbon nanotubes are not limited. The plurality of multi-walled carbon nanotubes can be disordered and arrange in various directions, or can be parallel to each other and extend along a same direction. The plurality of multi-walled carbon nanotubes extending in the same direction can be one or more, and the plurality of multi-walled carbon nanotubes are connected end to end by van der Waals force.

In one embodiment, the plurality of multi-walled carbon nanotubes are formed by a super-aligned carbon nanotube array. The super-aligned carbon nanotube array comprises a plurality of multi-walled carbon nanotubes, and the plurality of multi-walled carbon nanotubes are parallel to each other and perpendicular to a substrate. A length of each of the multi-walled carbon nanotube is about 300 micrometers. In one embodiment, The super-aligned carbon nanotube array consists of a plurality of multi-walled carbon nanotubes.

The super-aligned carbon nanotube array can be formed by the following substeps: (S1011) providing a substantially flat and smooth substrate; (S1012) forming a catalyst layer on the substrate; (S1013) annealing the substrate with the catalyst layer in air at a temperature ranging from about 700° C. to about 900° C. for about 30 to 90 minutes; (S1014) heating the substrate with the catalyst layer to a temperature ranged from about 500° C. to about 740° C. in a furnace with a protective gas therein; and (S1015) supplying a carbon source gas to the furnace for about 5 to 30 minutes and growing the super-aligned carbon nanotube array on the substrate.

In step (S1011), the substrate can be a P-type silicon wafer, an N-type silicon wafer, or a silicon wafer with a film of silicon dioxide thereon. In one embodiment, a 4-inch P-type silicon wafer is used as the substrate.

In step (S1012), the catalyst can be made of iron (Fe), cobalt (Co), nickel (Ni), or any alloy thereof.

The length of the super-aligned carbon nanotube array is about 200 μm to about 400 μm. The super-aligned carbon nanotube array formed under the above conditions is essentially free of impurities such as carbonaceous or residual catalyst particles. The multi-walled carbon nanotubes in the super-aligned carbon nanotube array are closely packed together by van der Waals attractive force.

At block S2 the heating furnace is a closed vessel, such as a tube furnace or a muffle furnace. In one embodiment, the heating furnace is just filled with pure carbon dioxide gas. In one embodiment, the at least one multi-walled carbon nanotube is placed in the tube furnace just filled with pure carbon dioxide gas.

At block S3, a heating time of the heating furnace is not limited. A heating process of the at least one multi-walled carbon nanotube in the heating furnace comprises the following steps: (S1031) heating the heating furnace at a constant rate until reaching a temperature ranged from about 800° C. to about 950° C.; (S1032) keeping heat the at least one multi-walled carbon nanotube at the temperature ranged from about 800° C. to about 950° C. for about 10 minutes to about 90 minutes. When the heating furnace is heated at the temperature ranged from about 800° C. to about 950° C., a mass loss of the at least one multi-walled carbon nanotube in the heating furnace is less than 20%. In other words, the at least one multi-walled carbon nanotube is oxidized in the carbon dioxide at the temperature ranged from about 800° C. to about 950° C. In one embodiment, the heating furnace is heated at a rate of 30° C. per minute filled with the carbon dioxide gas until the temperature reaches 900° C., and the at least one multi-walled carbon nanotube is heated at the temperature 900° C. for 60 minutes.

During the heating process, the carbon dioxide gas undergoes a redox reaction with carbon atoms on the surface of a multi-walled carbon nanotube to form a carbon monoxide.

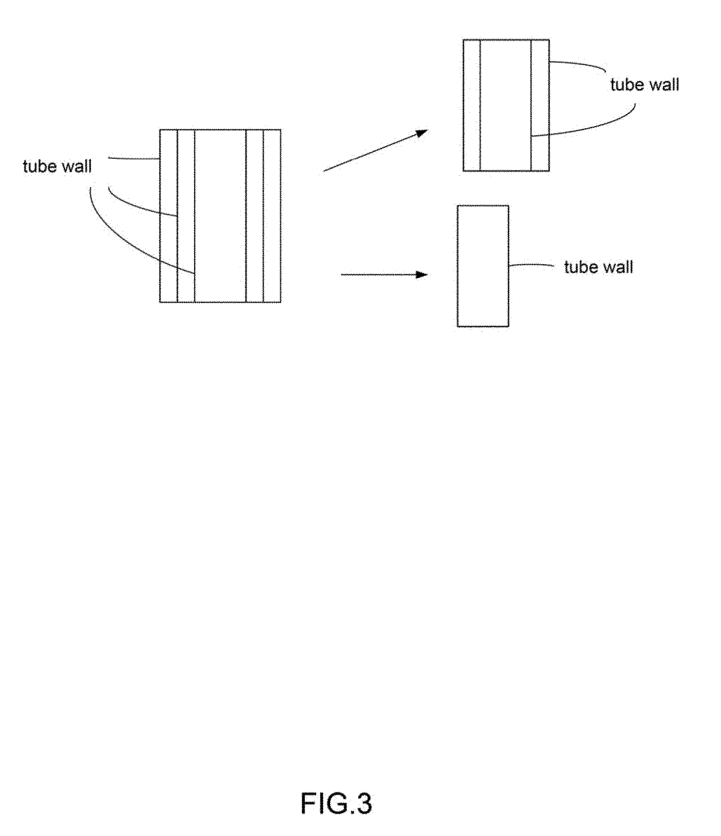

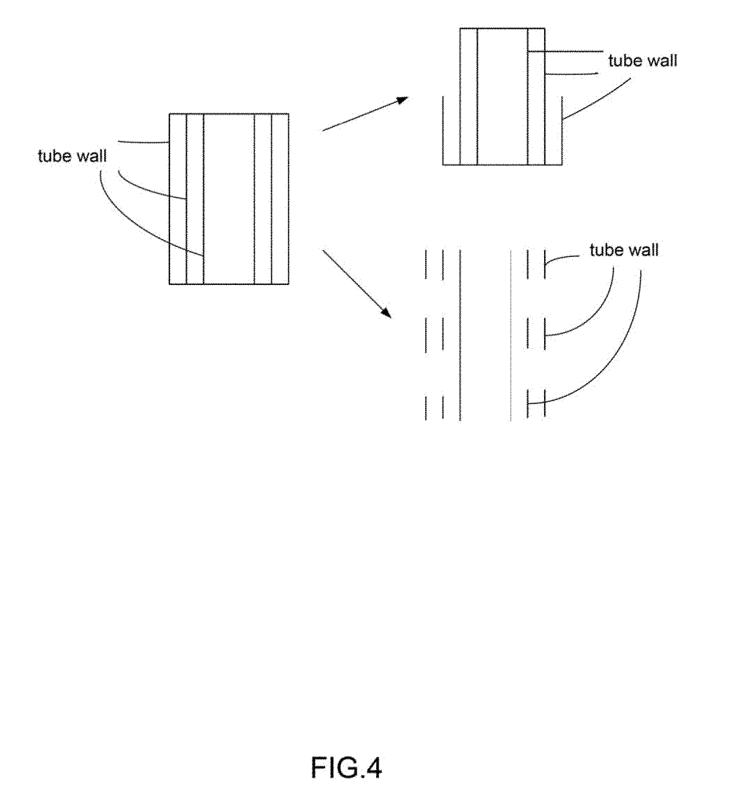

A multi-walled carbon nanotube tube wall is continuously peeled off, and the diameter of the multi-walled carbon nanotube is reduced. The peeling of the multi-walled carbon nanotube tube wall causes the mass loss of the multi-walled carbon nanotube. In one embodiments, the multi-walled carbon nanotube tube wall comprises three layers. As shown in FIG. 3, the multi-walled carbon nanotube tube wall can be completely peeled off; or as shown in FIG. 4, the multi-walled carbon nanotube tube wall can be partially peeled off to form a patterned multi-walled carbon nanotube. In one embodiment, one layer or two layers of the multi-walled carbon nanotube tube wall can be completely peeled off. In another embodiment, one layer or two layers of the multi-walled carbon nanotube tube wall can be partially peeled off. The multi-walled carbon nanotube tube wall continuously peeled off is a sheet structure. A shape of the sheet structure is determined by an oxidation reaction time of the multi-walled carbon nanotube in the carbon dioxide filled furnace and the heating temperature. In one embodiment, a thickness of the sheet structure is ranged from about 1 nm to about 3 nm, and a length of the sheet structure is 50 nm or more.

When the length of the multi-walled carbon nanotube is 300 micrometers or more, different locations of the multi-walled carbon nanotube tube wall can be continuously peeled off during the oxidation reaction to form the patterned multi-walled carbon nanotube. In the oxidation process, a complete layer of the multi-walled carbon nanotube tube wall may not be peeled off easily. Therefore, in order to peel off the layer of the multi-walled carbon nanotube tube wall completely, the length of the multi-walled carbon nanotube can be less than or equal to 100 μm. In one embodiment, the length of the multi-walled carbon nanotube can be less than or equal to 50 μm.

Since the carbon dioxide is a weak oxidant, in the oxidation process of the multi-walled carbon nanotube, the oxidization and peeling off processes will proceed preferentially along the length direction of the multi-walled carbon nanotube. Therefore, the structure of the multi-walled carbon nanotube may not be severely damaged, and the multi-walled carbon nanotube tube wall peeled off is the sheet structure. From a viewpoint of a functional group, a plurality of carbon-oxygen single bond functional groups appear at locations where the multi-walled carbon nanotube tube wall are peeled off. After the multi-walled carbon nanotube tube wall are continuously peeled off, the surface of the multi-walled carbon nanotube comprises a plurality of carbon-oxygen single bonds. In one embodiment, after the multi-walled carbon nanotube tube wall are continuously peeled off, the surface of the multi-walled carbon nanotube just has a plurality of carbon-oxygen single bonds.

After the multi-walled carbon nanotubes tube walls is continuously peeled off, the surface of the multi-walled carbon nanotube just has a carbon-oxygen single bond functional group and is negatively charged. The carbon-oxygen single bond functional group can be a hydroxyl group or a phenol group. Since an oxidative defect on the multi-walled carbon nanotube tube wall is uniform, the carbon-oxygen single bond functional group and the negative charge on the surface of the multi-walled carbon nanotubes are also uniform.

The present invention further compares two different oxidation methods: a method for oxidizing the multi-walled carbon nanotubes in carbon dioxide and a method for oxidizing the multi-walled carbon nanotubes in air. The term “carbon dioxide-oxidized multi-walled carbon nanotube” when utilized, means “the multi-walled carbon nanotube has been oxidized in the carbon dioxide”. The term “air-oxidized multi-walled carbon nanotube” when utilized, means “the multi-walled carbon nanotube has been oxidized in air”.

### Embodiment 1

In Embodiment 1, the multi-walled carbon nanotube is placed in the heating furnace filled with a pure carbon dioxide gas. The heating furnace is heated at a rate of 30° C. per minute until the temperature reaches 900° C., and continue heating the multi-walled carbon nanotube at the temperature 900° C. for 60 minutes.

### Comparative Embodiment 1

In Comparative Embodiment 1, the multi-walled carbon nanotube is placed in the heating furnace filled with air. The heating furnace is heated at a rate of 30° C. per minute until the temperature reaches 550° C., and continue heating the multi-walled carbon nanotube at the temperature 550° C. for 30 minutes.

The difference between the Embodiment 1 and the Comparative Embodiment 1 is that oxidation gases, oxidation temperature and oxidation time are different.

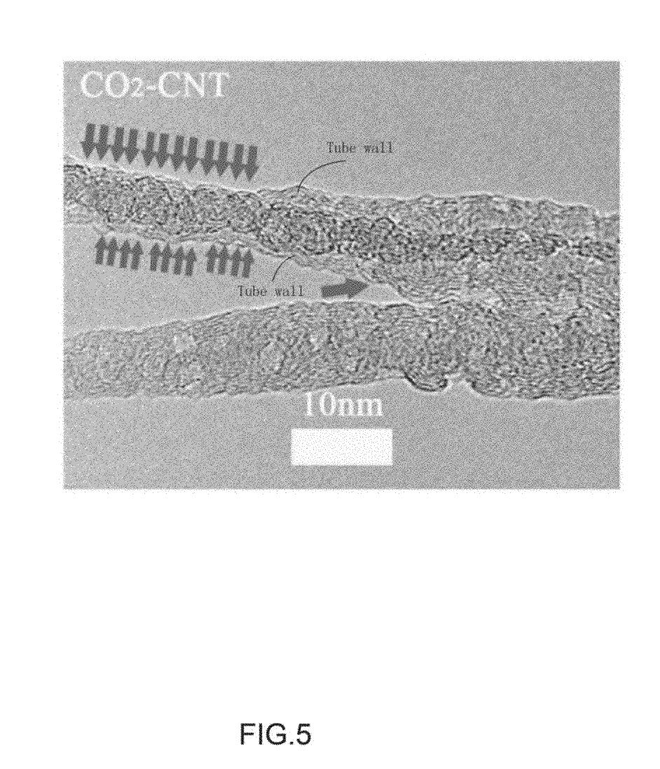

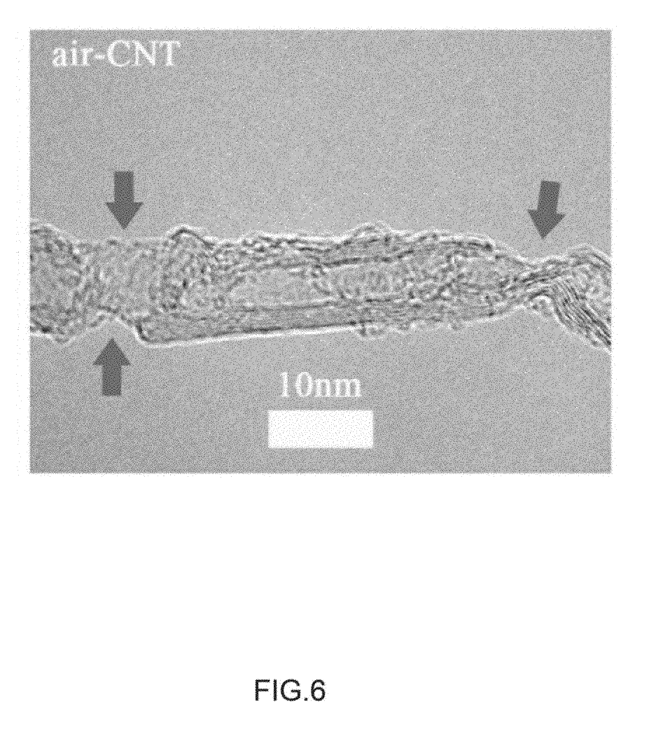

FIG. 5 is a transmission electron micrograph of the carbon dioxide-oxidized multi-walled carbon nanotube. FIG. 6 is a transmission electron micrograph of the air-oxidized multi-walled carbon nanotube. As shown in FIG. 5, a structure of the carbon dioxide-oxidized multi-walled carbon nanotube is not seriously damaged. Comparing FIG. 5 to FIG. 6, the multi-walled carbon nanotube tube walls oxidized by the carbon dioxide is continuously peeled off, and no pores are formed on the surface of the multi-walled carbon nanotube. Snice the multi-walled carbon nanotube is oxidized in oxygen, a part of the surface of the multi-walled carbon nanotube is severely deformed and a plurality of pores are formed.

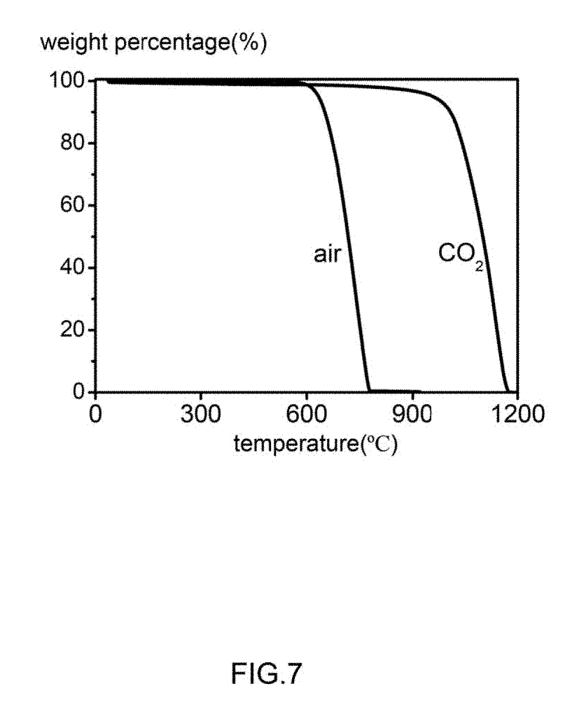

FIG. 7 is a thermogravimetric analysis curves comparison diagram of the carbon dioxide-oxidized multi-walled carbon nanotube and the air-oxidized multi-walled carbon nanotube (the mass fraction of the multi-walled carbon nanotubes at room temperature is 100 wt %). As shown in FIG. 7, the air-oxidized multi-walled carbon nanotube has a serious mass loss at the temperature in a range from about 651° C. to about 763° C., and a mass of multi-walled carbon nanotube is reduced from 90 wt % to 10 wt %. However, the carbon dioxide-oxidized multi-walled carbon nanotube has a severe mass loss at the temperature in a range from about 1009° C. to about 1154° C., and the mass of multi-walled carbon nanotube is reduced from 90 wt % to 10 wt %. In one embodiment, in order to obtain an oxidative modification of the multi-walled carbon nanotube without losing too much mass, the oxidation temperature of the multi-walled carbon nanotube in the carbon dioxide is about 900° C., the oxidation temperature of the multi-walled carbon nanotube in the air is about 550° C.

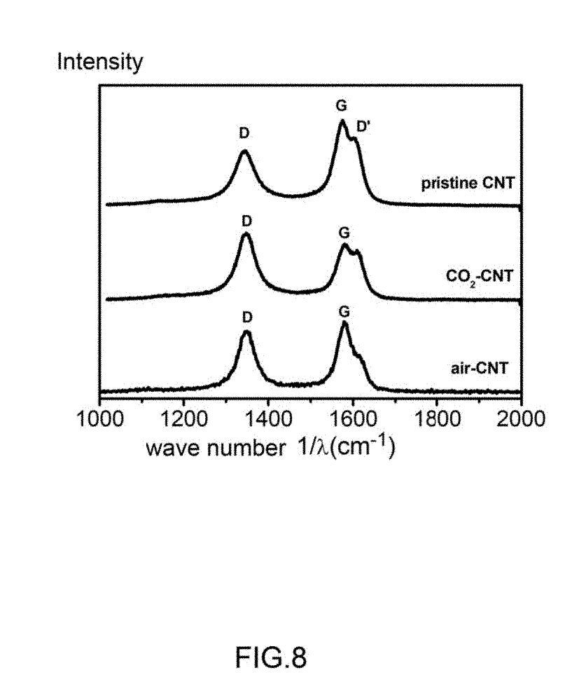

Referring to FIG. 8, the three curves respectively represent the Raman spectra of an untreated multi-walled carbon nanotube, the carbon dioxide-oxidized multi-walled carbon nanotubes, and the air-oxidized multi-walled carbon nanotubes. A relative value of an intensity of a D peak represents an amount of sp³ carbon atoms. That is, a six-membered ring of the multi-walled carbon nanotube is destroyed, and a destroyed location of the six-membered ring can be an oxidation site. The relative value of the intensity of a G peak represents an amount of sp² carbon atoms. That is, the six-membered ring of the multi-walled carbon nanotube is intact and not destroyed. As shown in FIG. 8, an intensity I_{D}/I_{G} ratio of the untreated multi-walled carbon nanotube is 0.636; the intensity I_{D}/I_{G} ratio of the carbon dioxide-oxidized multi-walled carbon nanotube is 1.204; and the intensity I_{D}/I_{G} ratio of the air-oxidized multi-walled carbon nanotube is 0.853. It is shown that the carbon dioxide-oxidized multi-walled carbon nanotube contains more oxidation sites.

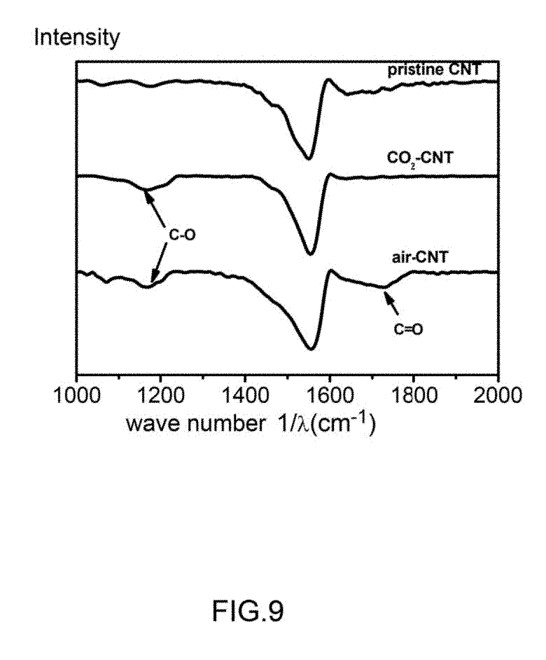

Referring to FIG. 9, the three curves respectively represent an infrared absorption spectra of the untreated multi-walled carbon nanotube, the carbon dioxide-oxidized multi-walled carbon nanotube, and the air-oxidized multi-walled carbon nanotube. As shown in FIG. 9, a number of the carbon-oxygen single bonds functional groups increases in locations of the multi-walled carbon nanotube tube walls peeled off, and a number of the carbon-oxygen double bonds functional groups do not increase, but instead the carbon-oxygen double bonds original existing on the multi-walled carbon nanotube are gone. A plurality of sp² hybridized carbon atoms on the intact six-membered ring are connected to a plurality of surrounding carbon atoms via three σ bonds (the π bond and the plurality of surrounding carbon atoms form a conjugation). The carbon atom of the carbon-oxygen single bond can be a sp³ hybridized carbon atom. The sp³ hybridized carbon atom is connected to three adjacent carbon atoms and one oxygen atom. Therefore, the carbon-oxygen single bond may not damage the six-membered ring, and the six-membered ring is not seriously deformed. The carbon atom of the carbon-oxygen double bonds can be the sp³ hybridized carbon atom. The sp³ hybridized carbon atom has four covalent bonds attached to the surrounding atoms, and at least two covalent bonds are connected to oxygen, less than two covalent bonds is connected to the carbon atom. This cannot occur on the intact six-membered ring. Therefore, the carbon-oxygen double bonds appear in the destroyed locations of the six-membered ring. As shown in the infrared spectrum, the carbon dioxide-oxidized multi-walled carbon nanotube has no carbon-oxygen double bonds. Therefore, the six-membered ring is not seriously damaged. Compared with the untreated multi-walled carbon nanotube, the air-oxidized multi-walled carbon nanotube comprise a plurality of C—O single bonds and C═O double bonds; the carbon dioxide-oxidized multi-walled carbon nanotubes just has a plurality of C—O single bonds. The C═O double bonds in the multi-walled carbon nanotube is removed by the carbon dioxide.

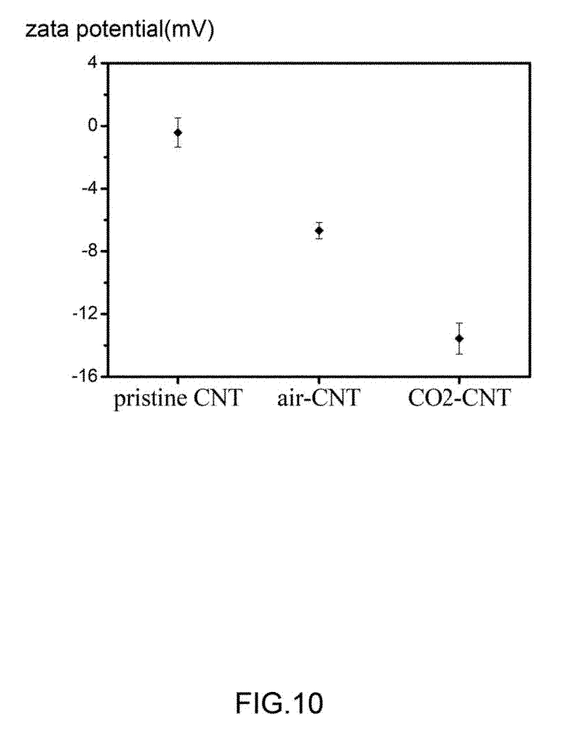

Referring to FIG. 10, three points in the figure respectively are zeta potentials obtained by testing the untreated multi-walled carbon nanotube, the carbon dioxide-oxidized multi-walled carbon nanotube, and the air-oxidized multi-walled carbon nanotube. As shown in FIG. 10, the zeta potential of the untreated multi-walled carbon nanotube is close to zero; the zeta potential of the air-oxidized multi-walled carbon nanotube is −6.6V; the zeta potential of the carbon dioxide-oxidized multi-walled carbon nanotube is −13.6V. Therefore, the surface of the carbon dioxide-oxidized multi-walled carbon nanotube has more negative charges.

The method for oxidizing multi-walled carbon nanotubes can modify the multi-walled carbon nanotube simply and quickly by using pure carbon dioxide gas without adding a solvent. Secondly, the surface of the multi-walled carbon nanotube is continuously peeled off and does not form pores by this method. The surface of the multi-walled carbon nanotubes just has a single C—O bond, and the negative charge is uniformly distributed on the surface of the multi-walled carbon nanotube.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may comprise some indication in reference to certain steps. However, the indication used is only to be viewed for identification purposes and not as a suggestion as to an order for the steps.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A method for oxidizing multi-walled carbon nanotubes, comprising:
providing at least one multi-walled carbon nanotube;
placing the at least one multi-walled carbon nanotube into a heating furnace filled with carbon dioxide gas; and
heating the heating furnace to a temperature ranged from about 800° C. to about 950° C., and oxidizing the at least one multi-walled carbon nanotube in the carbon dioxide.

2. The method as claimed in claim 1, wherein the heating furnace is heated to the temperature for about 900° C.

3. The method of claim 1, wherein the heating furnace is a tube furnace or a muffle furnace.

4. The method of claim 1, wherein the heating furnace is just filled with pure carbon dioxide gas.

5. The method of claim 1, wherein the at least one multi-walled carbon nanotube tube wall is continuously peeled off during heating of the heating furnace.

6. The method of claim 5, wherein a diameter of the multi-walled carbon nanotube is reduced.

7. The method of claim 5, wherein the at least one multi-walled carbon nanotube tube wall being peeled off is a sheet structure.

8. The method of claim 7, wherein a thickness of the sheet structure is ranged from about 1 nm to about 3 nm.

9. The method of claim 7, wherein a length of the sheet structure is greater than or equal to 50 nm.

10. The method of claim 5, wherein a plurality of C—O single bonds is formed on a surface of the at least one multi-walled carbon nanotube after the at least one multi-walled carbon nanotube tube wall is peeled off

11. The method of claim 5, wherein a surface of the at least one multi-walled carbon nanotube just comprises a plurality of C—O single bonds after the at least one multi-walled carbon nanotube tube wall is peeled off

12. The method of claim 1, wherein the at least one multi-walled carbon nanotube comprises a plurality of multi-walled carbon nanotubes, and the plurality of multi-walled carbon nanotubes are parallel to each other and extend along a same direction.
